(19) United States
(12) Patent Application Publication
(10) Pub. No.: US 2024/0364927 A1
(43) Pub. Date: Oct. 31, 2024

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Wenyi WANG, Beijing (CN); Yingzhan XU, Beijing (CN); Kai ZHANG, Los Angeles, CA (US); Li ZHANG, Los Angeles, CA (US)

(21) Appl. No.: 18/763,694

(22) Filed: Jul. 3, 2024

Related U.S. Application Data
(63) Continuation of application No. PCT/CN2023/070154, filed on Jan. 3, 2023.

(30) Foreign Application Priority Data
Jan. 4, 2022 (WO) PCT/CN2022/070181

(51) Int. Cl. H04N 19/597; H04N 19/96

(52) U.S. Cl. CPC H04N 19/597; H04N 19/96

(57) ABSTRACT

Embodiments of the present disclosure provide a solution for point cloud coding. A method for point cloud coding is proposed. The method comprises: determining, during a conversion between a current frame of a point cloud sequence and a bitstream of the point cloud sequence, an occupancy state of a first node of the current frame, a node representing a spatial partition of the current frame, the occupancy state of the first node representing whether the first node is occupied by a point; determining a prediction of an occupancy indication of a second node of the current frame, the occupancy indication indicating an occupancy state of the second node; and performing the conversion based on the prediction of the occupancy indication.

### CROSS-REFERENCE TO RELATED APPLICATIONS

This application is a continuation of International Application No. PCT/CN2023/070154, filed on Jan. 3, 2023, which claims the benefit of International Application No. PCT/CN2022/070181 filed on Jan. 4, 2022. The entire contents of these applications are hereby incorporated by reference in their entireties.

### FIELD

Embodiments of the present disclosure relates generally to video coding techniques, and more particularly, to occupancy state prediction.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, during a conversion between a current frame of a point cloud sequence and a bitstream of the point cloud sequence, an occupancy state of a first node of the current frame, a node representing a spatial partition of the current frame, the occupancy state of the first node representing whether the first node is occupied by a point; determining a prediction of an occupancy indication of a second node of the current frame, the occupancy indication indicating an occupancy state of the second node; and performing the conversion based on the prediction of the occupancy indication. The method in accordance with the first aspect of the present disclosure predicts an occupancy indication of a second node based on an occupancy state of a first node, and thus can improve the efficiency of the point cloud coding.

In a second aspect, another method for point cloud coding is proposed. The method comprises: determining, during a conversion between a current frame of a point cloud sequence and a bitstream of the point cloud sequence, at least one neighbour node of a current node of the current frame, a node representing a spatial partition of the current frame; determining a prediction of an occupancy indication of a sub-node of the current node based on at least one occupancy state of the at least one neighbour node, an occupancy state of a node representing whether the node is occupied by a point, the occupancy indication of a sub-node indicating an occupancy state of the sub-node; and performing the conversion based on the prediction of the occupancy indication. The method in accordance with the second aspect of the present disclosure predicts an occupancy indication of a sub-node based on an occupancy state of a neighbour node, and thus can improve the efficiency of the point cloud coding.

In a third aspect, another method for point cloud coding is proposed. The method comprises: determining, during a conversion between a current frame of a point cloud sequence and a bitstream of the point cloud sequence, at least one neighbour sub-node of a current node of the current frame, a node or a sub-node representing a spatial partition of the current frame; determining a prediction of an occupancy indication of a sub-node of the current node based on at least one occupancy state of the at least one neighbour sub-node, an occupancy state of a sub-node representing whether the sub-node is occupied by a point, the occupancy indication of a sub-node indicating an occupancy state of the sub-node; and performing the conversion based on the prediction of the occupancy indication. The method in accordance with the third aspect of the present disclosure predicts an occupancy indication of a sub-node based on an occupancy state of at least one neighbor sub-node, and thus can improve the efficiency of the point cloud coding.

In a fourth aspect, another method for point cloud coding is proposed. The method comprises: determining, during a conversion between a current frame of a point cloud sequence and a bitstream of the point cloud sequence, at least one preceding sub-node coded before a current sub-node of the current node, a node or a sub-node representing a spatial partition of the current frame; determining a prediction of an occupancy indication of the current sub-node based on at least one occupancy state of the at least one preceding sub-node, an occupancy state of a sub-node representing whether the sub-node is occupied by a point, the occupancy indication of a sub-node indicating an occupancy state of the sub-node; and performing the conversion based on the prediction of the occupancy indication. The method in accordance with the fourth aspect of the present disclosure predicts an occupancy indication of a sub-node based on an occupancy state of at least one preceding sub-node, and thus can improve the efficiency of the point cloud coding.

In a fifth aspect, another method for point cloud coding is proposed. The method comprises: determining, during a conversion between a current frame of a point cloud sequence and a bitstream of the point cloud sequence, a score based on a plurality of occupancy states of a plurality of nodes or a plurality of sub-nodes, a node or a sub-node representing a spatial partition of the current frame, an occupancy state of a sub-node representing whether the sub-node is occupied by a point; determining a prediction state of an occupancy indication of a sub-node of a current node of the current frame based on the score; and performing the conversion based on the prediction state. The method in accordance with the fifth aspect of the present disclosure determines a score based on occupancy states of nodes or sub-nodes and determines a prediction state based on the score, and thus can improve the efficiency of the point cloud coding.

In a sixth aspect, another method for point cloud coding is proposed. The method comprises: determining, during a conversion between a current frame of a point cloud sequence and a bitstream of the point cloud sequence, a density value of the current frame, the density value indicating a density of point in at least a partition of the current frame; determining at least one score threshold for determining a prediction state of a sub-node of a node of the current frame based on the density value, a node representing a spatial partition of the current frame; and performing the conversion based on the at least one score threshold. The method in accordance with the sixth aspect of the present disclosure determines at least one score threshold based on the density value of the frame, and thus can improve the efficiency of the point cloud coding.

In a seventh aspect, an apparatus for processing point cloud sequence is proposed. The apparatus for processing point cloud sequence comprises a processor and a non-transitory memory with instructions thereon. The instructions upon execution by the processor, cause the processor to perform a method in accordance with the first, second, third, fourth, fifth or sixth aspect of the present disclosure.

In an eighth aspect, a non-transitory computer-readable storage medium is proposed. The non-transitory computer-readable storage medium stores instructions that cause a processor to perform a method in accordance with the first, second, third, fourth, fifth or sixth aspect of the present disclosure.

In a ninth aspect, a non-transitory computer-readable recording medium is proposed. The non-transitory computer-readable recording medium stores a bitstream of a point cloud sequence which is generated by a method performed by a point cloud processing apparatus. The method comprises: determining an occupancy state of a first node of a current frame of the point cloud sequence, a node representing a spatial partition of the current frame, the occupancy state of the first node representing whether the first node is occupied by a point; determining a prediction of an occupancy indication of a second node of the current frame, the occupancy indication indicating an occupancy state of the second node; and generating the bitstream based on the prediction of the occupancy indication.

In a tenth aspect, a method for storing a bitstream of a point cloud sequence is proposed. The method comprises: determining an occupancy state of a first node of a current frame of the point cloud sequence, a node representing a spatial partition of the current frame, the occupancy state of the first node representing whether the first node is occupied by a point; determining a prediction of an occupancy indication of a second node of the current frame, the occupancy indication indicating an occupancy state of the second node; generating the bitstream based on the prediction of the occupancy indication; and storing the bitstream in a non-transitory computer-readable recording medium.

In an eleventh aspect, another non-transitory computer-readable recording medium is proposed. The non-transitory computer-readable recording medium stores a bitstream of a point cloud sequence which is generated by a method performed by a point cloud processing apparatus. The method comprises: determining at least one neighbour node of a current node of a current frame of the point cloud sequence, a node representing a spatial partition of the current frame; determining a prediction of an occupancy indication of a sub-node of the current node based on at least one occupancy state of the at least one neighbour node, an occupancy state of a node representing whether the node is occupied by a point, the occupancy indication of a sub-node indicating an occupancy state of the sub-node; and generating the bitstream based on the prediction of the occupancy indication.

In a twelfth aspect, a method for storing a bitstream of a point cloud sequence is proposed. The method comprises: determining at least one neighbour node of a current node of a current frame of the point cloud sequence, a node representing a spatial partition of the current frame; determining a prediction of an occupancy indication of a sub-node of the current node based on at least one occupancy state of the at least one neighbour node, an occupancy state of a node representing whether the node is occupied by a point, the occupancy indication of a sub-node indicating an occupancy state of the sub-node; generating the bitstream based on the prediction of the occupancy indication; and storing the bitstream in a non-transitory computer-readable recording medium.

In a thirteenth aspect, another non-transitory computer-readable recording medium is proposed. The non-transitory computer-readable recording medium stores a bitstream of a point cloud sequence which is generated by a method performed by a point cloud processing apparatus. The method comprises: determining at least one neighbour sub-node of a current node of a current frame of the point cloud sequence, a node or a sub-node representing a spatial partition of the current frame; determining a prediction of an occupancy indication of a sub-node of the current node based on at least one occupancy state of the at least one neighbour sub-node, an occupancy state of a sub-node representing whether the sub-node is occupied by a point, the occupancy indication of a sub-node indicating an occupancy state of the sub-node; and generating the bitstream based on the prediction of the occupancy indication.

In a fourteenth aspect, a method for storing a bitstream of a point cloud sequence is proposed. The method comprises: determining at least one neighbour sub-node of a current node of a current frame of the point cloud sequence, a node or a sub-node representing a spatial partition of the current frame; determining a prediction of an occupancy indication of a sub-node of the current node based on at least one occupancy state of the at least one neighbour sub-node, an occupancy state of a sub-node representing whether the sub-node is occupied by a point, the occupancy indication of a sub-node indicating an occupancy state of the sub-node; generating the bitstream based on the prediction of the occupancy indication; and storing the bitstream in a non-transitory computer-readable recording medium.

In a fifteenth aspect, another non-transitory computer-readable recording medium is proposed. The non-transitory computer-readable recording medium stores a bitstream of a point cloud sequence which is generated by a method performed by a point cloud processing apparatus. The method comprises: determining at least one preceding sub-node coded before a current sub-node of the current node, a node or a sub-node representing a spatial partition of a current frame of the point cloud sequence; determining a prediction of an occupancy indication of the current sub-node based on at least one occupancy state of the at least one preceding sub-node, an occupancy state of a sub-node representing whether the sub-node is occupied by a point, the occupancy indication of a sub-node indicating an occupancy state of the sub-node; and generating the bitstream based on the prediction of the occupancy indication.

In a sixtieth aspect, a method for storing a bitstream of a point cloud sequence is proposed. The method comprises: determining at least one preceding sub-node coded before a current sub-node of the current node, a node or a sub-node representing a spatial partition of a current frame of the point cloud sequence; determining a prediction of an occupancy indication of the current sub-node based on at least one occupancy state of the at least one preceding sub-node, an occupancy state of a sub-node representing whether the sub-node is occupied by a point, the occupancy indication of a sub-node indicating an occupancy state of the sub-node; generating the bitstream based on the prediction of the occupancy indication; and storing the bitstream in a non-transitory computer-readable recording medium.

In a seventeenth aspect, another non-transitory computer-readable recording medium is proposed. The non-transitory computer-readable recording medium stores a bitstream of a point cloud sequence which is generated by a method performed by a point cloud processing apparatus. The method comprises: determining a score based on a plurality of occupancy states of a plurality of nodes or a plurality of sub-nodes, a node or a sub-node representing a spatial partition of a current frame of the point cloud sequence, an occupancy state of a sub-node representing whether the sub-node is occupied by a point; determining a prediction state of an occupancy indication of a sub-node of a current node of the current frame based on the score; and generating the bitstream based on the prediction state.

In an eighteenth aspect, a method for storing a bitstream of a point cloud sequence is proposed. The method comprises: determining a score based on a plurality of occupancy states of a plurality of nodes or a plurality of sub-nodes, a node or a sub-node representing a spatial partition of a current frame of the point cloud sequence, an occupancy state of a sub-node representing whether the sub-node is occupied by a point; determining a prediction state of an occupancy indication of a sub-node of a current node of the current frame based on the score; generating the bitstream based on the prediction state; and storing the bitstream in a non-transitory computer-readable recording medium.

In a nineteenth aspect, another non-transitory computer-readable recording medium is proposed. The non-transitory computer-readable recording medium stores a bitstream of a point cloud sequence which is generated by a method performed by a point cloud processing apparatus. The method comprises: determining a density value of a current frame of the point cloud sequence, the density value indicating a density of point in at least a partition of the current frame; determining at least one score threshold for determining a prediction state of a sub-node of a node of the current frame based on the density value, a node representing a spatial partition of the current frame; and generating the bitstream based on the at least one score threshold.

In a twentieth aspect, a method for storing a bitstream of a point cloud sequence is proposed. The method comprises: determining a density value of a current frame of the point cloud sequence, the density value indicating a density of point in at least a partition of the current frame; determining at least one score threshold for determining a prediction state of a sub-node of a node of the current frame based on the density value, a node representing a spatial partition of the current frame; generating the bitstream based on the at least one score threshold; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example point cloud coding system, in accordance with some embodiments of the present disclosure;

FIG. 2 illustrates a block diagram that illustrates an example of a GPCC encoder, in accordance with some embodiments of the present disclosure;

FIG. 3 illustrates a block diagram that illustrates an example of a GPCC decoder, in accordance with some embodiments of the present disclosure;

FIG. 4 illustrates the 8 sub-nodes scanning order of transformed node;

FIG. 5 illustrates the 7 neighbours that share a face, an edge or a vertex with each sub-node m;

FIG. 6 illustrates an example of the improved point cloud geometry intra prediction coding;

FIG. 7 illustrates another example of the improved point cloud geometry intra prediction coding;

FIG. 8 illustrates a flowchart of a method for point cloud coding in accordance with some embodiments of the present disclosure;

FIG. 9 illustrates a flowchart of another method for point cloud coding in accordance with some embodiments of the present disclosure;

FIG. 10 illustrates a flowchart of another method for point cloud coding in accordance with some embodiments of the present disclosure;

FIG. 11 illustrates a flowchart of another method for point cloud coding in accordance with some embodiments of the present disclosure;

FIG. 12 illustrates a flowchart of another method for point cloud coding in accordance with some embodiments of the present disclosure;

FIG. 13 illustrates a flowchart of another method for point cloud coding in accordance with some embodiments of the present disclosure; and

FIG. 14 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

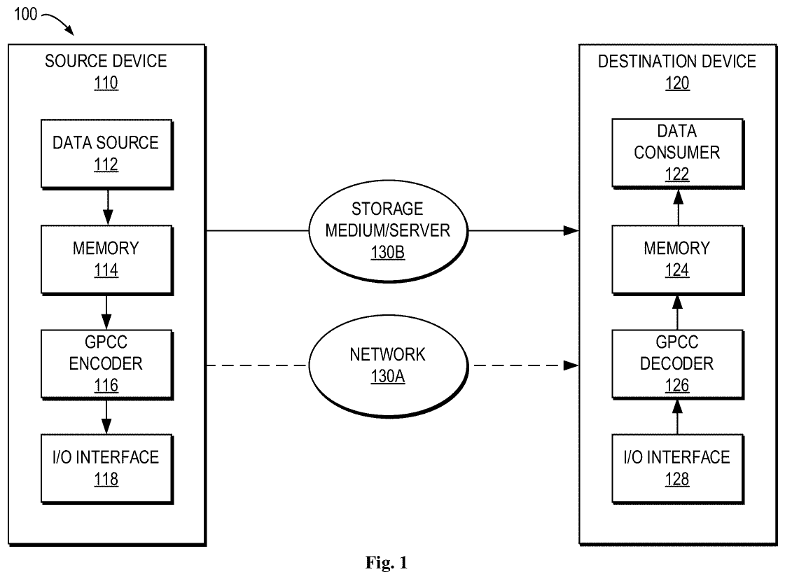

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

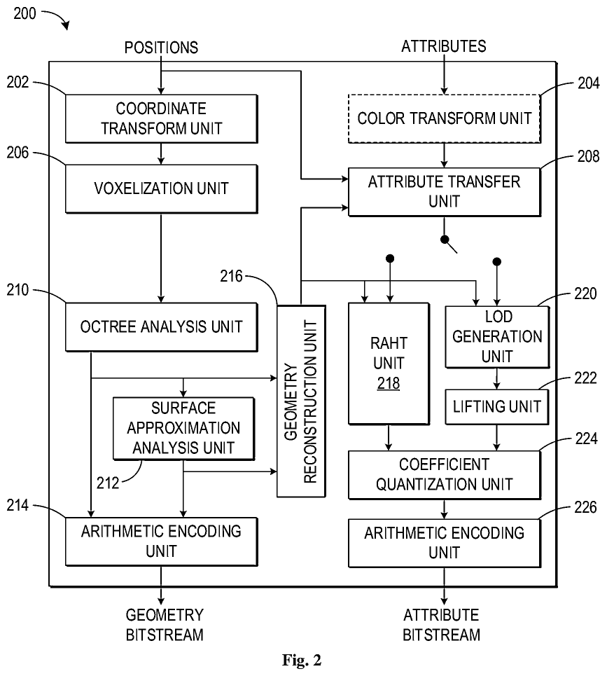

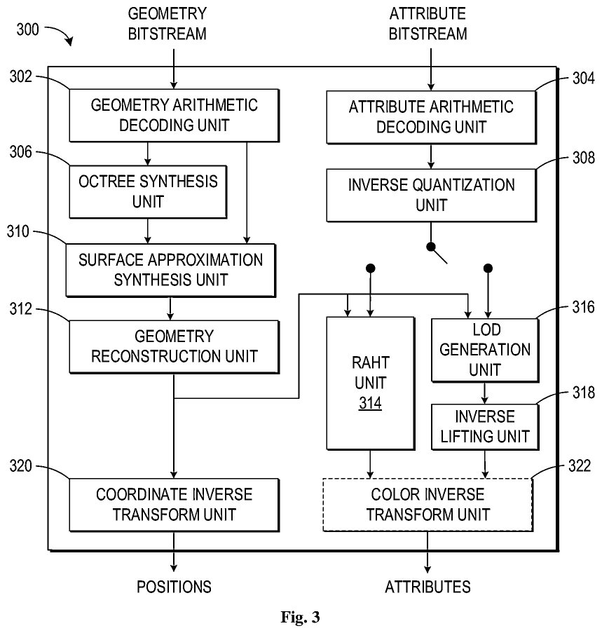

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Summary

This disclosure is related to point cloud coding technologies. Specifically, it is related to point cloud geometry intra prediction coding. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression,
MPEG Moving Picture Experts Group,
3DG 3D Graphics Coding Group,
CFP Call For Proposal,
V-PCC Video-based Point Cloud Compression.

### 3. Background

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Geometry Coding Tools in G-PCC

Point cloud codec can process the various information in different ways. Usually there are many optional tools in the codec to support the coding and decoding of geometry information and attribute information respectively. Among geometry coding tools in G-PCC, the following tools have an important influence for point cloud geometry coding performance.

### 3.1.1 Octree Geometry Compression

In G-PCC, one of important point cloud geometry coding tools is octree geometry compression, which leverages point cloud geometry spatial correlation. If geometry coding tools is enabled, a cubical axis-aligned bounding box, associated with octree root node, will be determined according to point cloud geometry information. Then the bounding box will be subdivided into 8 sub-cubes, which are associated with 8 sub-nodes of root node (a cube is equivalent to node hereafter). An 8-bit code is then generated by specific order to indicate whether the 8 sub-nodes contain points separately, where one bit is associated with one sub-node. The bit associated with one sub-node is named occupancy bit and the 8-bit code generated is named occupancy code. The generated occupancy code will be signaled according to the occupancy information of neighbor node. Then only the nodes which contain points will be subdivided into 8 sub-nodes furtherly. The process will be performed recursively until the node size is 1. So, the point cloud geometry information is converted into occupancy code sequences.

In decoder side, occupancy code sequences will be decoded and the point cloud geometry information can be reconstructed according to the occupancy code sequences.

### 3.1.2 Octree Node Scanning Order

A breadth-first scanning order will be used for the octree. In one level of the octree, the octree node will be scanned in a Morton order. If the coordinate of one node is represented by N bits, the coordinate (X, Y, Z) of the node can be represented as follows.

$$X = ( {x}_{N - 1} {x}_{N - 2} … {x}_{1} {x}_{0} )$$

$$Y = ( {y}_{N - 1} {y}_{N - 2} … {y}_{1} {y}_{0} )$$

$$Z = ( {z}_{N - 1} {z}_{N - 2} … {z}_{1} {z}_{0} )$$

Its Morton code can be represented as follows.

$$M = ( {x}_{N - 1} {y}_{N - 1} {z}_{N - 1} {x}_{N - 2} {y}_{N - 2} {z}_{N - 2} … {x}_{1} {y}_{1} {z}_{1} {x}_{0} {y}_{0} {z}_{0} )$$

The Morton order is the order from small to large according to Morton code.

### 3.1.3 Sub-node Scanning Order

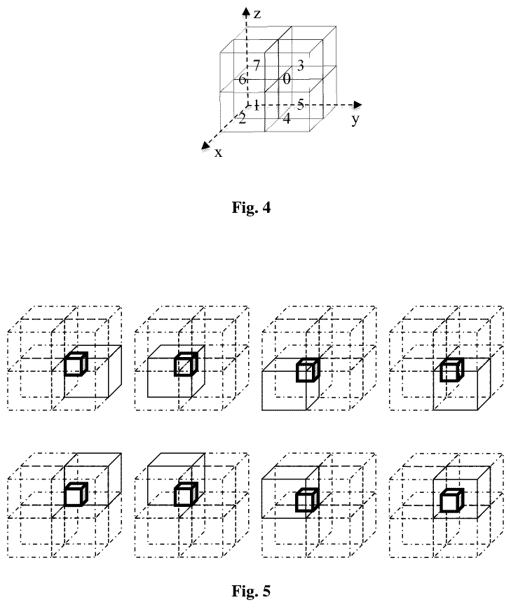

For one octree node, its 8 sub-nodes will be scanned in a specific order for better coding the occupancy code using neighbour information. Because using a breadth-first scanning order, whether the six neighbour node sharing a face with one node is occupied is known before coding the occupancy code of the node. So the six neighbour node occupancy information is used to coding the occupancy code of the node. For better leveraging the occupancy information of the six neighbour node, the node will be transformed in space according to the occupancy information of the six neighbour node. The 8 sub-nodes scanning order of transformed node is as FIG. 4.

### 3.1.4 Geometry Intra Prediction

Geometry intra prediction is introduced to enhance entropy coding efficiency of one node occupancy code according to the number of its occupied neighbours. Current geometry intra prediction will count the number of occupied neighbours, Nom, among the 7 neighbours that have the same octree depth with current node and share a face, an edge or a vertex with each sub-node m of current node, where m=0,1, . . . , 7. FIG. 5 illustrates the 7 neighbours that share a face, an edge or a vertex with each sub-node m. FIG. 5 shows the 7 neighbours distribution for each sub-node, where the solid line node is current node, the bold line node is the sub-node of current node, and the dash-dot line node is neighbours that share a face, an edge or a vertex with the sub-node in the neighbours of current node.

The occupied neighbours number Nom will be transformed into a ternary information Predm belonging to the three prediction states set {“predicted unoccupied”, “predicted occupied”, “unpredictable”} by using two thresholds Th₀ and Th₁. If the Nom is lower than or equal to Th₀, then Predm is set to “predicted unoccupied”; if the Nom is higher than or equal to Th₁, then Predm is set to “predicted occupied”; otherwise the occupied neighbours number Nom is between the two thresholds and Predm is set to “unpredictable”.

$${Pred}_{m} = \{ \begin{matrix}predicted unoccupied , if {No}_{m} \leq {Th}_{0} \\ predicted occupied , if {No}_{m} \geq {Th}_{1} \\ unpredictable , otherwise .\end{matrix}$$

The values of Th₀ and Th₁ are related to the number of occupied neighbours, No, among all the 26 neighbours that share a face, and edge or a vertex with the current node, which can take value from 0 to 26. In the last G-PCC specification, the value of Th₀ and Th₁ is as follows:

$$\{ \begin{matrix}{Th}_{0} = 2 , {Th}_{1} = 5 , & if No > 13 \\ {Th}_{0} = 2 , {Th}_{1} = 4 , & otherwise .\end{matrix}$$

Then the occupancy bit of each sub-node is arithmetically encoded or decoded using a binary arithmetic coder according to the prediction state Predm and other neighbour information.

### 3.2 Tile and Slice in G-PCC

Tile partitioning can be used to aid spatial random access and parallel encoding/decoding. Slice partitioning could also be used to further enhance parallelization, improve coding efficiency, and enable other functionalities such as error resiliency and progressive decoding.

In G-PCC, a slice is an unordered list of points and a tile is a set of slices. Slice point positions are coded relative to a slice origin in the coding coordinate system. The coded volumes of slices may intersect, including within a point cloud frame. A group of slices may be identified by a common per slice identifier (slice_tag). Each tile consists of a single bounding box and an identifier (tileld). Tile bounding boxes may overlap. When the tile functionality is enabled, slice_tag identify a tile by tileld.

### 4. Problems

The existing designs for point cloud geometry intra prediction coding have the following problems:
1. The number of occupied neighbours among the 7 neighbours that have the same octree depth with current node and share a face, an edge or a vertex with each sub-node of current node is counted to enhance entropy coding efficiency of the occupancy code. However, among the neighbours, some of them are encoded/decoded before current node. Consequently, the occupancy information of their sub-nodes is known when encoding/decoding the occupancy code of current node. If the the occupancy information of already-coded neighbours' sub-nodes can be used to predict the occupancy code of the current node, the geometry coding performance can be improved.
2. Only the occupancy information of the neighbours node that have the same octree depth with current node is used to enhance entropy coding efficiency of the occupancy code of current node. However, because the occupancy bit of sub-node of current node is encoded/decoded in a specific order, the occupancy information of preceding sub-nodes is known when encoding/decoding the occupancy bit of the current sub-node. Then the occupancy information of preceding sub-nodes can be used to better predict the occupancy bit of the current sub-node.

### 5. Detailed Description

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.
1) The occupancy state of one node A may be derived to predict the occupancy bit of another node B.
   a. In one example, node A and node B may share the same octree depth.
   b. In one example, node A and node B may have different octree depths.
   c. In one example, there may be two occupancy states, “occupied” or “non-occupied”.
      i. In one example, the occupancy state of node A may be derived based on the occupancy information of node B, such as the occupancy bit of the node, the number of occupied sub-node of the node, the number of points in the node and so on.
      ii. In one example, the occupancy state of node A may be derived based on the occupancy information of node A and/or its spatial relationship with node B.
2) The occupancy state of neighbour nodes that have the same octree depth with the current node may be used to predict the occupancy bit of each sub-node of the current node.
   a. In one example, there may be neighbour nodes that have the same octree depth with the current node.
      i. In one example, for each sub-node, one neighbour node may be one node that shares at least a plane, or an edge, or a vertex with the current sub-node.
      ii. Alternatively, for each sub-node, one neighbour node may be one node that shares at least a plane, or an edge, or a vertex with the current node.
      iii. Alternatively, one neighbour node may be one node that is near with the current sub-node or the current node.
   b. A score derived according to the occupancy state of neighbour nodes may determine the prediction state of the occupancy bit of each sub-node.
      i. In one example, the score may be the number of occupied neighbour nodes.
      ii. In one example, there is limited number of prediction states.
         1. In one example, there are 3 prediction states, “predicted unoccupied”, “predicted occupied” and “unpredictable”.
3) The occupancy state of the neighbour sub-nodes may be used to predict the occupancy bit of at least one sub-node of the current node.
   a. In one example, there may be neighbour sub-nodes for at least one sub-node of the current node.
      i. In one example, the neighbour sub-nodes may be the sub-nodes of neighbour nodes.
      ii. In one example, the neighbour sub-nodes are encoded/decoded before the sub-nodes of the current node.
      iii. In one example, the sub-nodes of neighbour node may share at least a plane, or an edge, or a vertex with the current sub-node.
      iv. Alternatively, the sub-nodes of neighbour node may share at least a plane, or an edge, or a vertex with the current node.
   b. In one example, the occupancy information of neighbour sub-nodes may be used to revise the occupancy state of its corresponding neighbour node.
      i. In one example, only if there is at least one occupied neighbour sub-node that share a face, an edge or a vertex with the current sub-node, the occupancy state of the neighbour node is regarded as “occupied”.
   c. In one example, a score derived according to the occupancy state of neighbour sub-nodes may determine the prediction state of the occupancy bit of the current sub-node.
      i. In one example, the score may be the number of occupied neighbour sub-nodes.
      ii. In one example, there is a limited number of prediction states.
         1. In one example, there are 3 prediction states, “predicted unoccupied”, “predicted occupied” and “unpredictable”.
4) The occupancy state of preceding sub-nodes may be used to predict the occupancy bit of the current sub-node.
   a. In one example, the preceding sub-nodes may be the sub-nodes of current node.
   b. Alternatively, the preceding sub-nodes may be the sub-nodes of any node encoded/decoded before current node.
   c. a score derived according to the occupancy state of preceding sub-nodes may determine the prediction state of the occupancy bit of the current sub-node.
      i. In one example, the score may be the number of occupied preceding sub-nodes.
5) A score derived according to the occupancy states of neighbour nodes, neighbour sub-nodes, preceding sub-nodes may determine the prediction state of the occupancy bit of the current sub-node.
   a. In one example, the score may be equal to the score derived according to the occupancy state of neighbour nodes.
   b. Alternatively, the score may be equal to the score derived according to the occupancy state of neighbour sub-nodes.
   c. Alternatively, the score may be equal to the score derived according to the occupancy state of preceding sub-nodes.
   d. Alternatively, the score may be equal to the fusion from the scores derived according to the occupancy state of neighbour nodes, neighbour sub-nodes and preceding sub-nodes.
      i. In one example, the score may be the sum of the scores derived according to the occupancy state of neighbour nodes, neighbour sub-nodes and preceding sub-nodes.
   e. In one example, the score may be compared with at least one score threshold to determine the prediction state of the current sub-node.
      i. In one example, the score threshold may be constant value.
      ii. Alternatively, the score threshold may be signaled in the bitstream.
      iii. Alternatively, the score threshold may be inferred according to decoded information.
6) A density value may be derived to determine at least one score threshold.
   a. In one example, the density value may be derived according to the number of occupied sub-nodes of preceding nodes which have the same octree depth with current node and are encoded/decoded before current node.
   b. Alternatively, the density value may be derived according to the number of occupied sub-nodes of the nodes which have the smaller octree depth than current node.
   c. Alternatively, the density value may be derived according to the number of occupied neighbours.
      i. In one example, the neighbour node may share a face, an edge or a vertex with the current sub-node.
      ii. Alternatively, the neighbour node may share a face, an edge or a vertex with the current node.
      iii. Alternatively, the neighbour node may be the node that is near with the current sub-node or the current node.
   d. In one example, the score threshold may be the function value of density value.
      i. In one example, the function may be constant function, piecewise function, linear function, power function, logarithmic function, exponential function and so on.
7) An indicator (e.g., being binary value) may be used to indicate whether the occupancy information of nodes that share the same octree depth with the current sub-node is used to predict the occupancy bit of the current sub-node.
   a. In one example, the indicator may be signaled in the bitstream.
   b. Alternatively, the indicator may be inferred in decoder and/or encoder side.
      i. In one example, the indicator may be inferred according to point cloud density.
   c. In one example, the indicator may be consistent in one coding unit.
      i. In one example, the coding unit may be frame.
      ii. Alternatively, the coding unit may be tile.
      iii. Alternatively, the coding unit may be slice.
      iv. Alternatively, the coding unit may be octree level.
   d. In one example, the indicator may be consistent in one point cloud sequence.
8) Whether to and/or how to apply a method disclosed above may be signaled from encoder to decoder in a bitstream/frame/tile/slice/octree/etc.

### 6. Embodiments

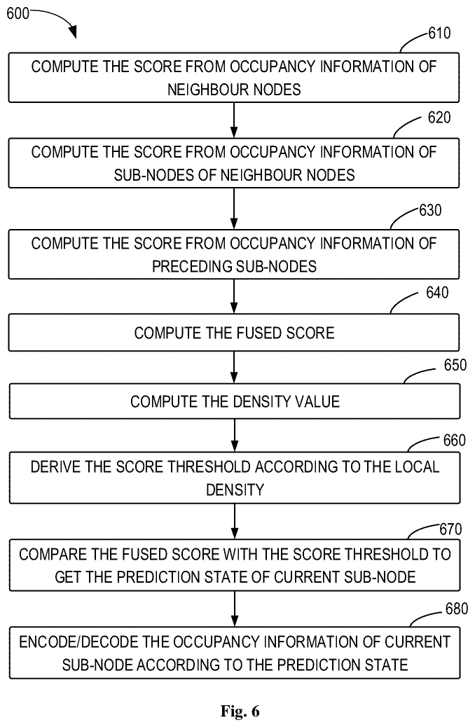

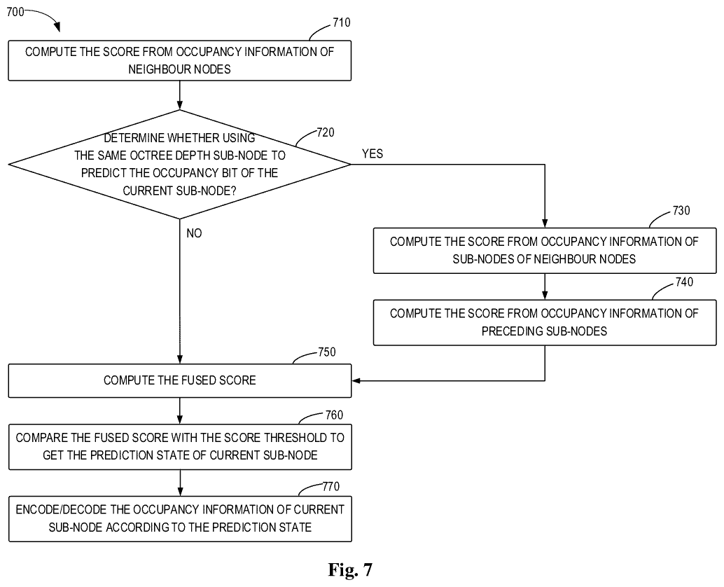

An example of the coding flow 600 for the improvement of point cloud geometry intra prediction coding is depicted in FIG. 6. At block 610, the score may be computed from occupancy information of neighbour nodes. At block 620, the score may be computed from occupancy information of sub-nodes of neighbour nodes. At block 630, the score may be computed from occupancy information of preceding sub-nodes. At block 640, the fused score may be computed. At block 650, the density value may be computed. At block 660, the score threshold may be derived according to the local density. At block 670, the fused score may be compared with the score threshold to get the prediction state of current sub-node. At block 680, the occupancy information of current sub-node may be encoded or decoded according to the prediction state.

Another example of the coding flow 700 for the improvement of point cloud geometry intra prediction coding is depicted in FIG. 7. At block 710, the score may be computed from occupancy information of neighbour nodes. At block 720, whether using the same octree depth sub-node to predict the occupancy bit of the current sub-node is determined. If at block 720 it is determined not to use the same octree depth sub-node, at block 750, the fused score is computed. If at block 720 it is determined to use the same octree depth sub-node, at block 730, the score may be computed from occupancy information of sub-nodes of neighbour nodes. At block 740, the score may be computed from occupancy information of preceding sub-nodes. At block 750, the fused score is computed. At block 760, the fused score may be compared with the score threshold to get the prediction state of current sub-node. At block 770, the occupancy information of current sub-node may be encoded or decoded according to the prediction state.

The embodiments of the present disclosure are related to motion information coding for point cloud coding. As used herein, the term “point cloud sequence” may refer to a sequence of one or more point clouds. The term “frame” may refer to a point cloud in a point cloud sequence. The term “point cloud” may refer to a frame in the point cloud sequence.

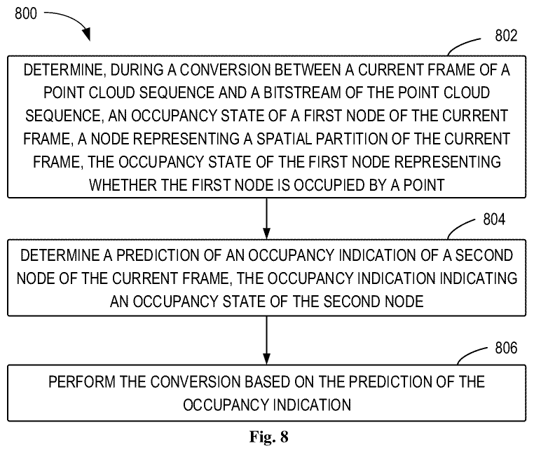

FIG. 8 illustrates a flowchart of method 800 for point cloud coding in accordance with some embodiments of the present disclosure. The method 800 may be implemented during a conversion between a current frame of a point cloud sequence and a bitstream of the point cloud sequence. As shown in FIG. 8, the method 800 starts at block 802, where an occupancy state of a first node of the current frame is determined. The node represents a spatial partition of the current frame. The occupancy state of the first node represents whether the first node is occupied by a point. At block 804, a prediction of an occupancy indication of a second node of the current frame is determined. The occupancy indication indicates an occupancy state of the second node. For example, the occupancy state of one node A may be derived to predict the occupancy bit of another node B. By predicting an occupancy indication of a second node based on an occupancy state of a first node, the coding efficiency can be improved.

At block 806, the conversion is performed based on the prediction of the occupancy indication. In some embodiments the conversion may include encoding the current frame into the bitstream. Alternatively, or in addition, the conversion may include decoding the current frame from the bitstream.

In some embodiments, the occupancy indication comprises an occupancy bit. For example, the occupancy bit may be 0 or 1.

In some embodiments, the first and second nodes have the same octree depth. In some embodiments, the first and second nodes have different octree depths.

In some embodiments, the occupancy state of the first node comprises one of: an occupied state, or a non-occupied state.

In some embodiments, at block 802, the occupancy state of the first node may be determined based on occupancy information of the second node. In one example, the occupancy state of node A may be derived based on the occupancy information of node B, such as the occupancy bit of the node, the number of occupied sub-node of the node, the number of points in the node and so on.

In some embodiments, the occupancy information of the second node comprises at least one of the following: an occupancy bit of the second node, a number of occupied sub-nodes of the second node, or a number of points in the second node.

In some embodiments, at block 802, the occupancy state of the first node may be determined based on at least one of: occupancy information of the first node or a spatial relationship between the first and second nodes. ii. In one example, the occupancy state of node A may be derived based on the occupancy information of node A and/or its spatial relationship with node B.

In some embodiments, the occupancy information of the first node comprises at least one of the following: an occupancy bit of the first node, a number of occupied sub-nodes of the first node, or a number of points in the first node.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, an occupancy state of a first node of a current frame of the point cloud sequence is determined. A node represents a spatial partition of the current frame. The occupancy state of the first node represents whether the first node is occupied by a point. A prediction of an occupancy indication of a second node of the current frame is determined. The occupancy indication indicates an occupancy state of the second node. The bitstream is generated based on the prediction of the occupancy indication.

According to embodiments of the present disclosure, a method for storing a bitstream of a point cloud sequence is proposed. In the method, an occupancy state of a first node of a current frame of the point cloud sequence is determined. A node represents a spatial partition of the current frame. The occupancy state of the first node represents whether the first node is occupied by a point. A prediction of an occupancy indication of a second node of the current frame is determined. The occupancy indication indicates an occupancy state of the second node. The bitstream is generated based on the prediction of the occupancy indication. The bitstream is stored in a non-transitory computer-readable recording medium.

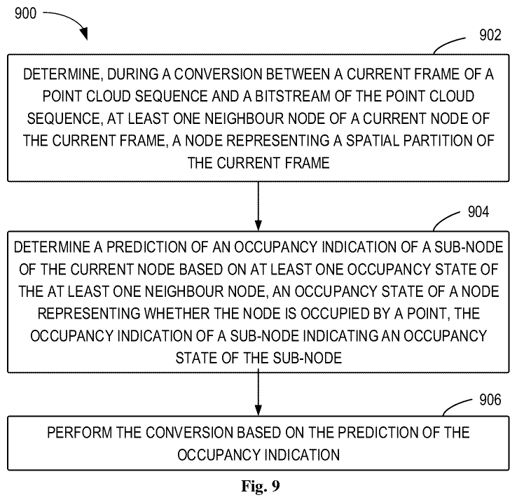

FIG. 9 illustrates a flowchart of method 900 for point cloud coding in accordance with some embodiments of the present disclosure. The method 900 may be implemented during a conversion between a current frame of a point cloud sequence and a bitstream of the point cloud sequence. As shown in FIG. 9, the method 900 starts at block 902, where at least one neighbour node of a current node of the current frame is determined. The node represents a spatial partition of the current frame. At block 904, a prediction of an occupancy indication of a sub-node of the current node is determined based on at least one occupancy state of the at least one neighbour node. An occupancy state of a node represents whether the node is occupied by a point. The occupancy indication of a sub-node indicates an occupancy state of the sub-node. By predicting an occupancy indication of a sub-node based on an occupancy state of a neighbour node, the coding efficiency can be improved.

At block 906, the conversion is performed based on the prediction of the occupancy indication. In some embodiments the conversion may include encoding the current frame into the bitstream. Alternatively, or in addition, the conversion may include decoding the current frame from the bitstream.

In some embodiments, the occupancy indication comprises an occupancy bit. For example, the occupancy bit may be 0 or 1.

In some embodiments, at block 904, for each sub-node of the current node, a prediction of an occupancy indication may be determined based on at least one occupancy state of the at least one neighbour node.

In some embodiments, the at least one neighbour node and the current node have the same octree depth. The occupancy state of neighbour nodes that have the same octree depth with the current node may be used to predict the occupancy bit of each sub-node of the current node.

In some embodiments, at block 902, for a sub-node of the current node, a node sharing at least one of the following with a sub-node of the current node may be determined as a neighbour node: a face, an edge or a vertex. In one example, for each sub-node, one neighbour node may be one node that shares at least a plane, or an edge, or a vertex with the current sub-node.

In some embodiments, at block 902, for a sub-node of the current node, a node sharing at least one of the following with the current node may be determined as a neighbour node: a face, an edge or a vertex. In one example, for each sub-node, one neighbour node may be one node that shares at least a plane, or an edge, or a vertex with the current node.

In some embodiments, at block 902, for a sub-node of the current node, distances between a plurality of nodes with the sub-node or distances between the plurality of nodes with the current node may be determined. At block 902, a node with a smallest distance may be determined as the at least one neighbor node. In one example, one neighbour node may be one node that is near with the current sub-node or the current node.

In some embodiments, the method 900 further comprises determining a score based on at least one occupancy state of the at least one neighbour node; and determining a prediction state of the occupancy indication of a sub-node of the current node based on the score. In some embodiments, a number of neighbour nodes with an occupied state may be determined as the score.

In some embodiments, the prediction state comprises one of a limited number of prediction states. By way of example, the limited number of prediction states comprise a predicted unoccupied state, a predicted occupied state and an unpredictable state.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, at least one neighbour node of a current node of a current frame of the point cloud sequence is determined. The node represents a spatial partition of the current frame. A prediction of an occupancy indication of a sub-node of the current node is determined based on at least one occupancy state of the at least one neighbour node. An occupancy state of a node represents whether the node is occupied by a point. The occupancy indication of a sub-node indicates an occupancy state of the sub-node. The bitstream is generated based on the prediction of the occupancy indication.

According to embodiments of the present disclosure, a method for storing a bitstream of a point cloud sequence is proposed. In the method, at least one neighbour node of a current node of a current frame of the point cloud sequence is determined. The node represents a spatial partition of the current frame. A prediction of an occupancy indication of a sub-node of the current node is determined based on at least one occupancy state of the at least one neighbour node. An occupancy state of a node represents whether the node is occupied by a point. The occupancy indication of a sub-node indicates an occupancy state of the sub-node. The bitstream is generated based on the prediction of the occupancy indication. The bitstream is stored in a non-transitory computer-readable recording medium.

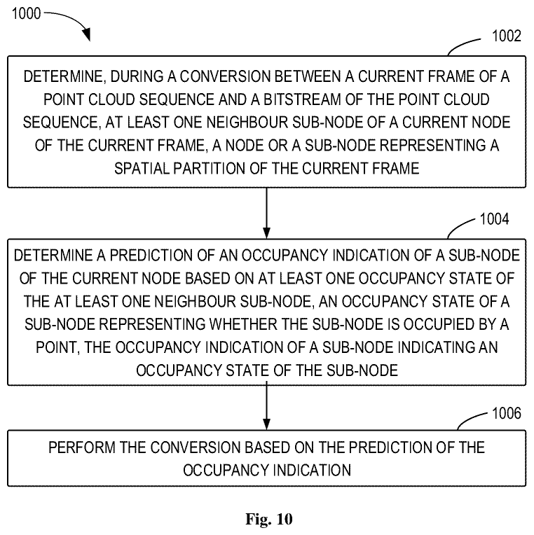

FIG. 10 illustrates a flowchart of method 1000 for point cloud coding in accordance with some embodiments of the present disclosure. The method 1000 may be implemented during a conversion between a current frame of a point cloud sequence and a bitstream of the point cloud sequence. As shown in FIG. 10, the method 1000 starts at block 1002, where at least one neighbour sub-node of a current node of the current frame is determined. A node or a sub-node represents a spatial partition of the current frame. At block 1004, a prediction of an occupancy indication of a sub-node of the current node is determined based on at least one occupancy state of the at least one neighbour sub-node. An occupancy state of a sub-node represents whether the sub-node is occupied by a point. The occupancy indication of a sub-node indicates an occupancy state of the sub-node. By predicting an occupancy indication of a sub-node based on an occupancy state of at least one neighbor sub-node, the coding efficiency can be improved.

At block 1006, the conversion is performed based on the prediction of the occupancy indication. In some embodiments the conversion may include encoding the current frame into the bitstream. Alternatively, or in addition, the conversion may include decoding the current frame from the bitstream.

In some embodiments, the occupancy indication comprises an occupancy bit. For example, the occupancy bit may be 0 or 1.

In some embodiments, the at least one neighbour sub-node of the current node comprises sub-nodes of a neighbour node of the current node.

In some embodiments, the at least one neighbour sub-node of the current node is coded before sub-nodes of the current node. In one example, the neighbour sub-nodes are encoded/decoded before the sub-nodes of the current node.

In some embodiments, the at least one neighbour sub-node of the current node share at least one of the following with the sub-node of the current node: a face, an edge or a vertex.

In some embodiments, the at least one neighbour sub-node of the current node share at least one of the following with the current node: a face, an edge or a vertex.

In some embodiments, the method 1000 further comprises revising an occupancy state of a neighbour node corresponding to the at least one neighbour sub-node based on occupancy information of the at least one neighbour sub-node. In one example, the occupancy information of neighbour sub-nodes may be used to revise the occupancy state of its corresponding neighbour node.

In some embodiments, if a neighbour sub-node of the at least one neighbour sub-node with an occupied state shares at least one of the following with the sub-node of the current node: a face, an edge, or a vertex, the occupancy state of the neighbour node may be revised as an occupied state. In one example, only if there is at least one occupied neighbour sub-node that share a face, an edge or a vertex with the current sub-node, the occupancy state of the neighbour node is regarded as “occupied”.

In some embodiments, the method 1000 further comprises determining a score based on at least one occupancy state of the at least one neighbour sub-node; and determining a prediction state of the occupancy indication of a sub-node of the current node based on the score. In some embodiments, a number of neighbour sub-nodes with an occupied state may be determined as the score.

In some embodiments, the prediction state comprises one of a limited number of prediction states. By way of example, the limited number of prediction states comprise a predicted unoccupied state, a predicted occupied state and an unpredictable state.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, at least one neighbour sub-node of a current node of a current frame of the point cloud sequence is determined. A node or a sub-node represents a spatial partition of the current frame. A prediction of an occupancy indication of a sub-node of the current node is determined based on at least one occupancy state of the at least one neighbour sub-node. An occupancy state of a sub-node represents whether the sub-node is occupied by a point. The occupancy indication of a sub-node indicates an occupancy state of the sub-node. The bitstream is generated based on the prediction of the occupancy indication.

According to embodiments of the present disclosure, a method for storing a bitstream of a point cloud sequence is proposed. In the method, at least one neighbour sub-node of a current node of a current frame of the point cloud sequence is determined. A node or a sub-node represents a spatial partition of the current frame. A prediction of an occupancy indication of a sub-node of the current node is determined based on at least one occupancy state of the at least one neighbour sub-node. An occupancy state of a sub-node represents whether the sub-node is occupied by a point. The occupancy indication of a sub-node indicates an occupancy state of the sub-node. The bitstream is generated based on the prediction of the occupancy indication. The bitstream is stored in a non-transitory computer-readable recording medium.

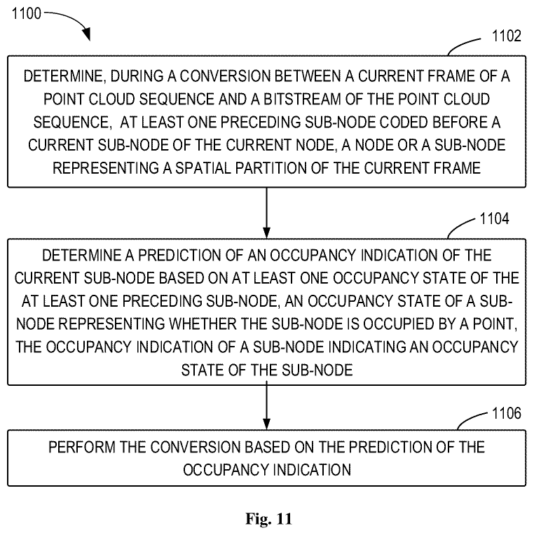

FIG. 11 illustrates a flowchart of method 1100 for point cloud coding in accordance with some embodiments of the present disclosure. The method 1100 may be implemented during a conversion between a current frame of a point cloud sequence and a bitstream of the point cloud sequence. As shown in FIG. 11, the method 1100 starts at block 1102, where at least one preceding sub-node coded before a current sub-node of the current node is determined. A node or a sub-node represents a spatial partition of the current frame. At block 1104, a prediction of an occupancy indication of the current sub-node is determined based on at least one occupancy state of the at least one preceding sub-node. An occupancy state of a sub-node represents whether the sub-node is occupied by a point. The occupancy indication of a sub-node indicates an occupancy state of the sub-node. By predicting an occupancy indication of a sub-node based on an occupancy state of at least one preceding sub-node, the coding efficiency can be improved.

At block 1106, the conversion is performed based on the prediction of the occupancy indication. In some embodiments the conversion may include encoding the current frame into the bitstream. Alternatively, or in addition, the conversion may include decoding the current frame from the bitstream.

In some embodiments, the occupancy indication comprises an occupancy bit. For example, the occupancy bit may be 0 or 1.

In some embodiments, the at least one preceding sub-node comprises sub-nodes of the current node.

Alternatively, or in addition, in some embodiments, the at least one preceding sub-node comprises sub-nodes of a node coded before the current node. For example, the preceding sub-nodes may be the sub-nodes of any node encoded/decoded before current node.

In some embodiments, the method 1100 further comprises determining a score based on at least one occupancy state of the at least one preceding sub-node; and determining a prediction state of the occupancy indication of a sub-node of the current node based on the score. In some embodiments, a number of preceding sub-nodes with an occupied state may be determined as the score.

In some embodiments, the prediction state comprises one of a limited number of prediction states. By way of example, the limited number of prediction states comprise a predicted unoccupied state, a predicted occupied state and an unpredictable state.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, at least one preceding sub-node coded before a current sub-node of the current node is determined. A node or a sub-node represents a spatial partition of the current frame. A prediction of an occupancy indication of the current sub-node is determined based on at least one occupancy state of the at least one preceding sub-node. An occupancy state of a sub-node represents whether the sub-node is occupied by a point. The occupancy indication of a sub-node indicates an occupancy state of the sub-node. The bitstream is generated based on the prediction of the occupancy indication.

According to embodiments of the present disclosure, a method for storing a bitstream of a point cloud sequence is proposed. In the method, at least one preceding sub-node coded before a current sub-node of the current node is determined. A node or a sub-node represents a spatial partition of the current frame. A prediction of an occupancy indication of the current sub-node is determined based on at least one occupancy state of the at least one preceding sub-node. An occupancy state of a sub-node represents whether the sub-node is occupied by a point. The occupancy indication of a sub-node indicates an occupancy state of the sub-node. The bitstream is generated based on the prediction of the occupancy indication. The bitstream is stored in a non-transitory computer-readable recording medium.

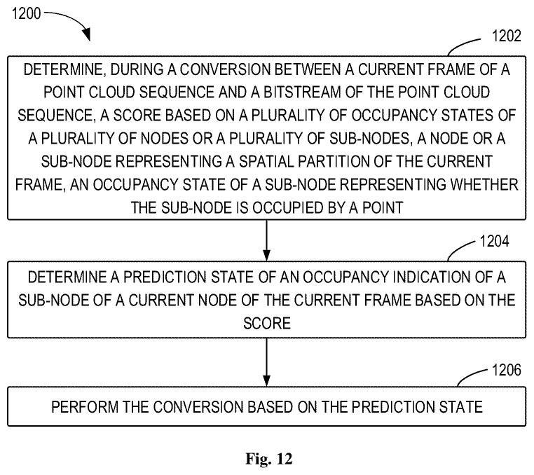

FIG. 12 illustrates a flowchart of method 1200 for point cloud coding in accordance with some embodiments of the present disclosure. The method 1200 may be implemented during a conversion between a current frame of a point cloud sequence and a bitstream of the point cloud sequence. As shown in FIG. 12, the method 1200 starts at block 1202, where a score is determined based on a plurality of occupancy states of a plurality of nodes or a plurality of sub-nodes. A node or a sub-node represents a spatial partition of the current frame. An occupancy state of a sub-node represents whether the sub-node is occupied by a point. At block 1204, a prediction state of an occupancy indication of a sub-node of a current node of the current frame is determined based on the score. By determining a score based on occupancy states of nodes or sub-nodes, a prediction state can be determined based on the score, and thus the coding efficiency can be improved.

At block 1206, a conversion between the current frame of the point cloud sequence and the bitstream of the point cloud sequence is performed based on the prediction state. In some embodiments the conversion may include encoding the current frame into the bitstream. Alternatively, or in addition, the conversion may include decoding the current frame from the bitstream.

In some embodiments, the plurality of nodes or the plurality of sub-nodes comprises one of the following: a plurality of neighbour nodes of the current node, a plurality of neighbour sub-nodes of the current node, or a plurality of preceding sub-nodes coded before the current node. That is, a score derived according to the occupancy states of neighbour nodes, neighbour sub-nodes, preceding sub-nodes may determine the prediction state of the occupancy bit of the current sub-node.

In some embodiments, at block 1202, the score may be determined based on a plurality of occupancy states of a plurality of neighbour nodes.

In some embodiments, at block 1202, the score may be determined based on a plurality of occupancy states of a plurality of neighbour sub-nodes.

In some embodiments, at block 1202, the score may be determined based on a plurality of occupancy states of a plurality of preceding sub-nodes coded before the current node.

In some embodiments, at block 1202, a first score may be determined based on a plurality of occupancy states of a plurality of neighbour nodes. A second score may be determined based on a plurality of occupancy states of a plurality of neighbour sub-nodes. A third score may be determined based on a plurality of occupancy states of a plurality of preceding sub-nodes coded before the current node. The score may be determined based on the first, second and third scores. That is, the score may be equal to the fusion from the scores derived according to the occupancy state of neighbour nodes, neighbour sub-nodes and preceding sub-nodes. By way of example, a sum or a weighted sum of the first, second and third scores may be determined as the score.

In some embodiments, at block 1204, the prediction state may be determined by comparing the score with at least one score threshold. By way of example, the prediction state comprises one of: a predicted unoccupied state, a predicted occupied state and an unpredictable state.

In some embodiments, the at least one score threshold comprises a constant value.

In some embodiments, the method 1200 further comprises including the at least one score threshold in the bitstream. Alternatively, or in addition, in some embodiments, the method 1200 further comprises determining the at least one score threshold based on decoded information.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a score is determined based on a plurality of occupancy states of a plurality of nodes or a plurality of sub-nodes. A node or a sub-node represents a spatial partition of a current frame of the point cloud sequence. An occupancy state of a sub-node represents whether the sub-node is occupied by a point. A prediction state of an occupancy indication of a sub-node of a current node of the current frame is determined based on the score. The bitstream is generated based on the prediction state.

According to embodiments of the present disclosure, a method for storing a bitstream of a point cloud sequence is proposed. In the method, a score is determined based on a plurality of occupancy states of a plurality of nodes or a plurality of sub-nodes. A node or a sub-node represents a spatial partition of a current frame of the point cloud sequence. An occupancy state of a sub-node represents whether the sub-node is occupied by a point. A prediction state of an occupancy indication of a sub-node of a current node of the current frame is determined based on the score. The bitstream is generated based on the prediction state. The bitstream is stored in a non-transitory computer-readable recording medium.

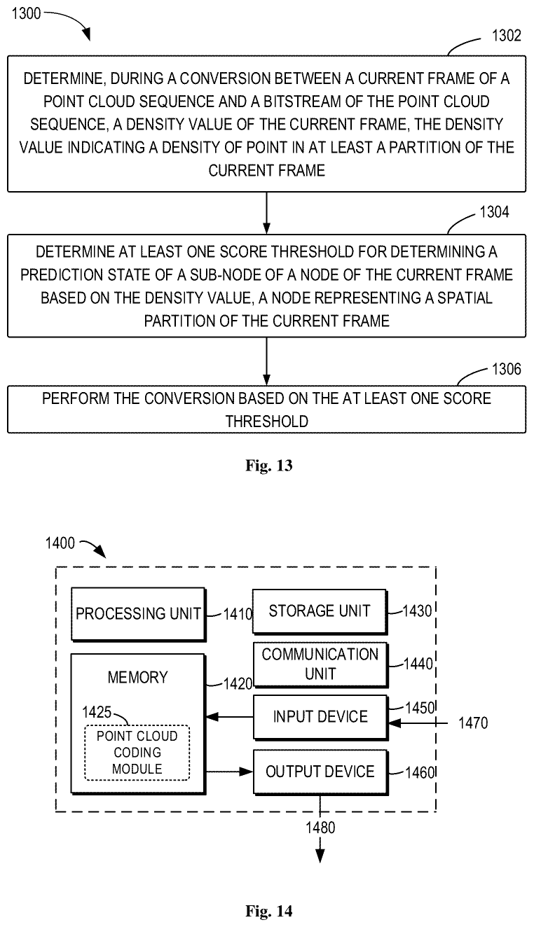

FIG. 13 illustrates a flowchart of method 1300 for point cloud coding in accordance with some embodiments of the present disclosure. The method 1300 may be implemented during a conversion between a current frame of a point cloud sequence and a bitstream of the point cloud sequence. As shown in FIG. 13, the method 1300 starts at block 1302, where a density value of the current frame is determined. The density value indicates a density of point in at least a partition of the current frame. At block 1304, at least one score threshold for determining a prediction state of a sub-node of a node of the current frame is determined based on the density value. A node represents a spatial partition of the current frame. By determining the at least one score threshold based on the density value, the coding efficiency can be improved.

At block 1306, a conversion between the current frame of the point cloud sequence and the bitstream of the point cloud sequence is performed based on the at least one score threshold. In some embodiments, the conversion may include encoding the current frame into the bitstream. Alternatively, or in addition, the conversion may include decoding the current frame from the bitstream.

In some embodiments, at block 1302, the density value may be determined based on a number of occupied sub-nodes of preceding nodes coded before the current node. The preceding nodes have the same octree depth with the current node.

In some embodiments, at block 1302, the density value may be determined based on a number of occupied sub-nodes of preceding nodes coded before the current node. The preceding nodes have a smaller octree depth than the current node.

In some embodiments, at block 1302, the density value may be determined based on a number of occupied neighbour nodes of the current node.

In some embodiments, the occupied neighbour nodes share at least one of the following with a sub-node of the current node: a face, an edge, or a vertex.

In some embodiments, the occupied neighbour nodes share at least one of the following with the current node: a face, an edge, or a vertex.

In some embodiments, the occupied neighbour nodes have a smallest distance with a sub-node of the current node or with the current node among a plurality of nodes.

In some embodiments, at block 1304, the at least one score threshold may be determined based on a metric of the density value.

By way of example, the metric comprises one of the following: a constant metric, a piecewise metric, a linear metric, a power metric, a logarithmic metric, an exponential metric, or any other suitable metric or function.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a score is determined based on a plurality of occupancy states of a plurality of nodes or a plurality of sub-nodes. A node or a sub-node represents a spatial partition of a current frame of the point cloud sequence. An occupancy state of a sub-node represents whether the sub-node is occupied by a point. A prediction state of an occupancy indication of a sub-node of a current node of the current frame is determined based on the score. The bitstream is generated based on the prediction state.

According to embodiments of the present disclosure, a method for storing a bitstream of a point cloud sequence is proposed. In the method, a score is determined based on a plurality of occupancy states of a plurality of nodes or a plurality of sub-nodes. A node or a sub-node represents a spatial partition of a current frame of the point cloud sequence. An occupancy state of a sub-node represents whether the sub-node is occupied by a point. A prediction state of an occupancy indication of a sub-node of a current node of the current frame is determined based on the score. The bitstream is generated based on the prediction state. The bitstream is stored in a non-transitory computer-readable recording medium.

It is to be understood that the above method 800, method 900, method 1000, method 1100, method 1200 and/or method 1300 may be used in combination or separately. Any suitable combination of these methods may be applied. Scope of the present disclosure is not limited in this regard.

In some embodiments, an indicator indicating whether to apply the methods 800, 900, 1000, 1100, 1200 and/or 1300 may be included in the bitstream. By way of example, the indicator may be included from an encoder to a decoder in one of the following: the bitstream, a frame, a tile, a slice, or an octree.

In some example embodiments, an indicator indicating whether to apply the methods 800, 900, 1000, 1100, 1200 and/or 1300 may be determined by at least one of: an encoder or a decoder. Bay way of example, the indicator may be determined based on a point cloud density. In some example embodiments, the indicator comprises a binary value.

In some example embodiments, the indicator indicates whether occupancy information of nodes having the same octree depth with a current sub-node of the current frame is used to predict an occupancy bit of the current sub-node. That is, an indicator (e.g., being binary value) may be used to indicate whether the occupancy information of nodes that share the same octree depth with the current sub-node is used to predict the occupancy bit of the current sub-node.

In some example embodiments, the indicator is consistent in a coding unit. By way of example, the coding unit comprises one of the following: a frame, a tile, a slice, or an octree level.

In some example embodiments, the indicator is consistent in the point cloud sequence.

In some example embodiments, information indicating how to apply the methods 800, 900, 1000, 1100, 1200 and/or 1300 may be included in the bitstream. By way of example, the information may be included from an encoder to a decoder in one of the following: the bitstream, a frame, a tile, a slice, or an octree.

By using these methods 800, 900, 1000, 1100, 1200 and/or 1300 separately or in combination, the coding effectiveness and coding efficiency of the point cloud coding can be improved.

Implementations of the present disclosure can be described in view of the following clauses, the features of which can be combined in any reasonable manner.

Clause 1. A method for point cloud coding, comprising: determining, during a conversion between a current frame of a point cloud sequence and a bitstream of the point cloud sequence, an occupancy state of a first node of the current frame, a node representing a spatial partition of the current frame, the occupancy state of the first node representing whether the first node is occupied by a point; determining a prediction of an occupancy indication of a second node of the current frame, the occupancy indication indicating an occupancy state of the second node; and performing the conversion based on the prediction of the occupancy indication.

Clause 2. The method of clause 1, wherein the occupancy indication comprises an occupancy bit.

Clause 3. The method of clause 1 or clause 2, wherein the first and second nodes have the same octree depth.

Clause 4. The method of clause 1 or clause 2, wherein the first and second nodes have different octree depths.

Clause 5. The method of any of clauses 1-4, wherein the occupancy state of the first node comprises one of: an occupied state, or a non-occupied state.

Clause 6. The method of any of clauses 1-5, wherein determining the occupancy state of the first node comprises: determining the occupancy state of the first node based on occupancy information of the second node.

Clause 7. The method of clause 6, wherein the occupancy information of the second node comprises at least one of the following: an occupancy bit of the second node, a number of occupied sub-nodes of the second node, or a number of points in the second node.

Clause 8. The method of any of clauses 1-7, wherein determining the occupancy state of the first node comprises: determining the occupancy state of the first node based on at least one of: occupancy information of the first node or a spatial relationship between the first and second nodes.

Clause 9. The method of clause 8, wherein the occupancy information of the first node comprises at least one of the following: an occupancy bit of the first node, a number of occupied sub-nodes of the first node, or a number of points in the first node.

Clause 10. A method for point cloud coding, comprising: determining, during a conversion between a current frame of a point cloud sequence and a bitstream of the point cloud sequence, at least one neighbour node of a current node of the current frame, a node representing a spatial partition of the current frame; determining a prediction of an occupancy indication of a sub-node of the current node based on at least one occupancy state of the at least one neighbour node, an occupancy state of a node representing whether the node is occupied by a point, the occupancy indication of a sub-node indicating an occupancy state of the sub-node; and performing the conversion based on the prediction of the occupancy indication.

Clause 11. The method of clause 10, wherein the occupancy indication comprises an occupancy bit.

Clause 12. The method of clause 10 or clause 11, wherein determining a prediction of an occupancy indication of a sub-node of the current node based on at least one occupancy state of the at least one neighbour node comprises: for each sub-node of the current node, determining a prediction of an occupancy indication based on at least one occupancy state of the at least one neighbour node.

Clause 13. The method of any of clauses 10-12, wherein the at least one neighbour node and the current node have the same octree depth.

Clause 14. The method of any of clauses 10-13, wherein determining at least one neighbour node of the current node comprises: for a sub-node of the current node, determining a node sharing at least one of the following with a sub-node of the current node as a neighbour node: a face, an edge or a vertex.

Clause 15. The method of any of clauses 10-13, wherein determining at least one neighbour node of the current node comprises: for a sub-node of the current node, determining a node sharing at least one of the following with the current node as a neighbour node: a face, an edge or a vertex.

Clause 16. The method of any of clauses 10-13, wherein determining at least one neighbour node of the current node comprises: for a sub-node of the current node, determining distances between a plurality of nodes with the sub-node or distances between the plurality of nodes with the current node; and determining a node with a smallest distance as the at least one neighbor node.

Clause 17. The method of any of clauses 10-16, further comprising: determining a score based on at least one occupancy state of the at least one neighbour node; and determining a prediction state of the occupancy indication of a sub-node of the current node based on the score.

Clause 18. The method of clause 17, wherein determining the score comprises: determining a number of neighbour nodes with an occupied state as the score.

Clause 19. The method of clause 17 or clause 18, wherein the prediction state comprises one of a limited number of prediction states.

Clause 20. The method of clause 19, wherein the limited number of prediction states comprise a predicted unoccupied state, a predicted occupied state and an unpredictable state.

Clause 21. A method for point cloud coding, comprising: determining, during a conversion between a current frame of a point cloud sequence and a bitstream of the point cloud sequence, at least one neighbour sub-node of a current node of the current frame, a node or a sub-node representing a spatial partition of the current frame; determining a prediction of an occupancy indication of a sub-node of the current node based on at least one occupancy state of the at least one neighbour sub-node, an occupancy state of a sub-node representing whether the sub-node is occupied by a point, the occupancy indication of a sub-node indicating an occupancy state of the sub-node; and performing the conversion based on the prediction of the occupancy indication.

Clause 22. The method of clause 21, wherein the occupancy indication comprises an occupancy bit.

Clause 23. The method of clause 21 or clause 22, wherein the at least one neighbour sub-node of the current node comprises sub-nodes of a neighbour node of the current node.

Clause 24. The method of any of clauses 21-23, wherein the at least one neighbour sub-node of the current node is coded before sub-nodes of the current node.

Clause 25. The method of any of clauses 21-24, wherein the at least one neighbour sub-node of the current node share at least one of the following with the sub-node of the current node: a face, an edge or a vertex.

Clause 26. The method of any of clauses 21-24, wherein the at least one neighbour sub-node of the current node share at least one of the following with the current node: a face, an edge or a vertex.

Clause 27. The method of any of clauses 21-26, further comprising: revising an occupancy state of a neighbour node corresponding to the at least one neighbour sub-node based on occupancy information of the at least one neighbour sub-node.

Clause 28. The method of clause 27, wherein revising an occupancy state of a neighbour node comprises: if a neighbour sub-node of the at least one neighbour sub-node with an occupied state shares at least one of the following with the sub-node of the current node: a face, an edge, or a vertex, revising the occupancy state of the neighbour node as an occupied state.

Clause 29. The method of any of clauses 21-28, further comprising: determining a score based on at least one occupancy state of the at least one neighbour sub-node; and determining a prediction state of the occupancy indication of a sub-node of the current node based on the score.

Clause 30. The method of clause 29, wherein determining the score comprises: determining a number of neighbour sub-nodes with an occupied state as the score.

Clause 31. The method of clause 29 or clause 30, wherein the prediction state comprises one of a limited number of prediction states.

Clause 32. The method of clause 31, wherein the limited number of prediction states comprise a predicted unoccupied state, a predicted occupied state and an unpredictable state.

Clause 33. A method for point cloud coding, comprising: determining, during a conversion between a current frame of a point cloud sequence and a bitstream of the point cloud sequence, at least one preceding sub-node coded before a current sub-node of the current node, a node or a sub-node representing a spatial partition of the current frame; determining a prediction of an occupancy indication of the current sub-node based on at least one occupancy state of the at least one preceding sub-node, an occupancy state of a sub-node representing whether the sub-node is occupied by a point, the occupancy indication of a sub-node indicating an occupancy state of the sub-node; and performing the conversion based on the prediction of the occupancy indication.

Clause 34. The method of clause 33, wherein the at least one preceding sub-node comprises sub-nodes of the current node.

Clause 35. The method of clause 33 or clause 34, wherein the at least one preceding sub-node comprises sub-nodes of a node coded before the current node.

Clause 36. The method of any of clauses 33-35, wherein the occupancy indication comprises an occupancy bit.

Clause 37. The method of any of clauses 33-36, further comprising: determining a score based on at least one occupancy state of the at least one preceding sub-node; and determining a prediction state of the occupancy indication of a sub-node of the current node based on the score.

Clause 38. The method of clause 37, wherein determining the score comprises: determining a number of preceding sub-nodes with an occupied state as the score.

Clause 39. The method of clause 37 or clause 38, wherein the prediction state comprises one of a limited number of prediction states.

Clause 40. The method of clause 39, wherein the limited number of prediction states comprise a predicted unoccupied state, a predicted occupied state and an unpredictable state.

Clause 41. A method for point cloud coding, comprising: determining, during a conversion between a current frame of a point cloud sequence and a bitstream of the point cloud sequence, a score based on a plurality of occupancy states of a plurality of nodes or a plurality of sub-nodes, a node or a sub-node representing a spatial partition of the current frame, an occupancy state of a sub-node representing whether the sub-node is occupied by a point; determining a prediction state of an occupancy indication of a sub-node of a current node of the current frame based on the score; and performing the conversion based on the prediction state.

Clause 42. The method of clause 41, wherein the plurality of nodes or the plurality of sub-nodes comprises one of the following: a plurality of neighbour nodes of the current node, a plurality of neighbour sub-nodes of the current node, or a plurality of preceding sub-nodes coded before the current node.

Clause 43. The method of clause 41 or clause 42, wherein determining a score based on a plurality of occupancy states comprises: determining the score based on a plurality of occupancy states of a plurality of neighbour nodes.

Clause 44. The method of clause 41 or clause 42, wherein determining a score based on a plurality of occupancy states comprises: determining the score based on a plurality of occupancy states of a plurality of neighbour sub-nodes.

Clause 45. The method of clause 41 or clause 42, wherein determining a score based on a plurality of occupancy states comprises: determining the score based on a plurality of occupancy states of a plurality of preceding sub-nodes coded before the current node.

Clause 46. The method of clause 41 or clause 42, wherein determining a score based on a plurality of occupancy states comprises: determining a first score based on a plurality of occupancy states of a plurality of neighbour nodes. determining a second score based on a plurality of occupancy states of a plurality of neighbour sub-nodes. determining a third score based on a plurality of occupancy states of a plurality of preceding sub-nodes coded before the current node; and determining the score based on the first, second and third scores.

Clause 47. The method of clause 46, wherein determining the score based on the first, second and third scores comprises: determining a sum of the first, second and third scores as the score.

Clause 48. The method of any of clauses 41-47, wherein determining a prediction state of an occupancy indication of a sub-node based on the score comprises: determining the prediction state by comparing the score with at least one score threshold.

Clause 49. The method of clause 48, wherein the at least one score threshold comprises a constant value.

Clause 50. The method of clause 48 or clause 49, further comprising: including the at least one score threshold in the bitstream.

Clause 51. The method of clause 48 or clause 49, further comprising: determining the at least one score threshold based on decoded information.

Clause 52. The method of any of clauses 41-51, wherein the prediction state comprises one of: a predicted unoccupied state, a predicted occupied state and an unpredictable state.

Clause 53. A method for point cloud coding, comprising: determining, during a conversion between a current frame of a point cloud sequence and a bitstream of the point cloud sequence, a density value of the current frame, the density value indicating a density of point in at least a partition of the current frame; determining at least one score threshold for determining a prediction state of a sub-node of a node of the current frame based on the density value, a node representing a spatial partition of the current frame; and performing the conversion based on the at least one score threshold.

Clause 54. The method of clause 53, wherein determining the density value comprises: determining the density value based on a number of occupied sub-nodes of preceding nodes coded before the current node, the preceding nodes having the same octree depth with the current node.

Clause 55. The method of clause 53, wherein determining the density value comprises: determining the density value based on a number of occupied sub-nodes of preceding nodes coded before the current node, the preceding nodes having a smaller octree depth than the current node.

Clause 56. The method of clause 53, wherein determining the density value comprises: determining the density value based on a number of occupied neighbour nodes of the current node.

Clause 57. The method of clause 56, wherein the occupied neighbour nodes share at least one of the following with a sub-node of the current node: a face, an edge, or a vertex.

Clause 58. The method of clause 56, wherein the occupied neighbour nodes share at least one of the following with the current node: a face, an edge, or a vertex.

Clause 59. The method of clause 56, wherein the occupied neighbour nodes have a smallest distance with a sub-node of the current node or with the current node among a plurality of nodes.

Clause 60. The method of any of clauses 53-59, wherein determining at least one score threshold based on the density value comprises: determining the at least one score threshold based on a metric of the density value.

Clause 61. The method of clause 60, wherein the metric comprises one of the following: a constant metric, a piecewise metric, a linear metric, a power metric, a logarithmic metric, or an exponential metric.

Clause 62. The method of any of clauses 1-61, further comprising: including an indicator indicating whether to apply the method in the bitstream.

Clause 63. The method of clause 62, wherein including an indicator in the bitstream comprises: including the indicator from an encoder to a decoder in one of the following: the bitstream, a frame, a tile, a slice, or an octree.

Clause 64. The method of any of clauses 1-61, further comprising: determining an indicator indicating whether to apply the method by at least one of: an encoder or a decoder.

Clause 65. The method of clause 64, wherein determining the indicator comprises: determining the indicator based on a point cloud density.

Clause 66. The method of any of clauses 62-65, wherein the indicator comprises a binary value.

Clause 67. The method of any of clauses 62-66, wherein the indicator indicates whether occupancy information of nodes having the same octree depth with a current sub-node of the current frame is used to predict an occupancy bit of the current sub-node.

Clause 68. The method of any of clauses 62-67, wherein the indicator is consistent in a coding unit.

Clause 69. The method of clause 68, wherein the coding unit comprises one of the following: a frame, a tile, a slice, or an octree level.

Clause 70. The method of any of clauses 62-69, wherein the indicator is consistent in the point cloud sequence.

Clause 71. The method of any of clauses 1-70, further comprising: including information indicating how to apply the method in the bitstream.

Clause 72. The method of clause 71, wherein including information in the bitstream comprises: including the information from an encoder to a decoder in one of the following: the bitstream, a frame, a tile, a slice, or an octree.

Clause 73. The method of any of clauses 1-72, wherein the conversion includes encoding the current frame into the bitstream.

Clause 74. The method of any of clauses 1-72, wherein the conversion includes decoding the current frame from the bitstream.

Clause 75. An apparatus for processing point cloud data comprising a processor and a non-transitory memory with instructions thereon, wherein the instructions upon execution by the processor, cause the processor to perform a method in accordance with any of clauses 1-74.

Clause 76. A non-transitory computer-readable storage medium storing instructions that cause a processor to perform a method in accordance with any of clauses 1-74.

Clause 77. A non-transitory computer-readable recording medium storing a bitstream of a point cloud sequence which is generated by a method performed by a point cloud processing apparatus, wherein the method comprises: determining an occupancy state of a first node of a current frame of the point cloud sequence, a node representing a spatial partition of the current frame, the occupancy state of the first node representing whether the first node is occupied by a point; determining a prediction of an occupancy indication of a second node of the current frame, the occupancy indication indicating an occupancy state of the second node; and generating the bitstream based on the prediction of the occupancy indication.

Clause 78. A method for storing a bitstream of a point cloud sequence, comprising: determining an occupancy state of a first node of a current frame of the point cloud sequence, a node representing a spatial partition of the current frame, the occupancy state of the first node representing whether the first node is occupied by a point; determining a prediction of an occupancy indication of a second node of the current frame, the occupancy indication indicating an occupancy state of the second node; generating the bitstream based on the prediction of the occupancy indication; and storing the bitstream in a non-transitory computer-readable recording medium.

Clause 79. A non-transitory computer-readable recording medium storing a bitstream of a point cloud sequence which is generated by a method performed by a point cloud processing apparatus, wherein the method comprises: determining at least one neighbour node of a current node of a current frame of the point cloud sequence, a node representing a spatial partition of the current frame; determining a prediction of an occupancy indication of a sub-node of the current node based on at least one occupancy state of the at least one neighbour node, an occupancy state of a node representing whether the node is occupied by a point, the occupancy indication of a sub-node indicating an occupancy state of the sub-node; and generating the bitstream based on the prediction of the occupancy indication.

Clause 80. A method for storing a bitstream of a point cloud sequence, comprising: determining at least one neighbour node of a current node of a current frame of the point cloud sequence, a node representing a spatial partition of the current frame; determining a prediction of an occupancy indication of a sub-node of the current node based on at least one occupancy state of the at least one neighbour node, an occupancy state of a node representing whether the node is occupied by a point, the occupancy indication of a sub-node indicating an occupancy state of the sub-node; generating the bitstream based on the prediction of the occupancy indication; and storing the bitstream in a non-transitory computer-readable recording medium.

Clause 81. A non-transitory computer-readable recording medium storing a bitstream of a point cloud sequence which is generated by a method performed by a point cloud processing apparatus, wherein the method comprises: determining at least one neighbour sub-node of a current node of a current frame of the point cloud sequence, a node or a sub-node representing a spatial partition of the current frame; determining a prediction of an occupancy indication of a sub-node of the current node based on at least one occupancy state of the at least one neighbour sub-node, an occupancy state of a sub-node representing whether the sub-node is occupied by a point, the occupancy indication of a sub-node indicating an occupancy state of the sub-node; and generating the bitstream based on the prediction of the occupancy indication.

Clause 82. A method for storing a bitstream of a point cloud sequence, comprising: determining at least one neighbour sub-node of a current node of a current frame of the point cloud sequence, a node or a sub-node representing a spatial partition of the current frame; determining a prediction of an occupancy indication of a sub-node of the current node based on at least one occupancy state of the at least one neighbour sub-node, an occupancy state of a sub-node representing whether the sub-node is occupied by a point, the occupancy indication of a sub-node indicating an occupancy state of the sub-node; generating the bitstream based on the prediction of the occupancy indication; and storing the bitstream in a non-transitory computer-readable recording medium.

Clause 83. A non-transitory computer-readable recording medium storing a bitstream of a point cloud sequence which is generated by a method performed by a point cloud processing apparatus, wherein the method comprises: determining at least one preceding sub-node coded before a current sub-node of the current node, a node or a sub-node representing a spatial partition of a current frame of the point cloud sequence; determining a prediction of an occupancy indication of the current sub-node based on at least one occupancy state of the at least one preceding sub-node, an occupancy state of a sub-node representing whether the sub-node is occupied by a point, the occupancy indication of a sub-node indicating an occupancy state of the sub-node; and generating the bitstream based on the prediction of the occupancy indication.

Clause 84. A method for storing a bitstream of a point cloud sequence, comprising: determining at least one preceding sub-node coded before a current sub-node of the current node, a node or a sub-node representing a spatial partition of a current frame of the point cloud sequence; determining a prediction of an occupancy indication of the current sub-node based on at least one occupancy state of the at least one preceding sub-node, an occupancy state of a sub-node representing whether the sub-node is occupied by a point, the occupancy indication of a sub-node indicating an occupancy state of the sub-node; generating the bitstream based on the prediction of the occupancy indication; and storing the bitstream in a non-transitory computer-readable recording medium.

Clause 85. A non-transitory computer-readable recording medium storing a bitstream of a point cloud sequence which is generated by a method performed by a point cloud processing apparatus, wherein the method comprises: determining a score based on a plurality of occupancy states of a plurality of nodes or a plurality of sub-nodes, a node or a sub-node representing a spatial partition of a current frame of the point cloud sequence, an occupancy state of a sub-node representing whether the sub-node is occupied by a point; determining a prediction state of an occupancy indication of a sub-node of a current node of the current frame based on the score; and generating the bitstream based on the prediction state.

Clause 86. A method for storing a bitstream of a point cloud sequence, comprising: determining a score based on a plurality of occupancy states of a plurality of nodes or a plurality of sub-nodes, a node or a sub-node representing a spatial partition of a current frame of the point cloud sequence, an occupancy state of a sub-node representing whether the sub-node is occupied by a point; determining a prediction state of an occupancy indication of a sub-node of a current node of the current frame based on the score; generating the bitstream based on the prediction state; and storing the bitstream in a non-transitory computer-readable recording medium.

Clause 87. A non-transitory computer-readable recording medium storing a bitstream of a point cloud sequence which is generated by a method performed by a point cloud processing apparatus, wherein the method comprises: determining a density value of a current frame of the point cloud sequence, the density value indicating a density of point in at least a partition of the current frame; determining at least one score threshold for determining a prediction state of a sub-node of a node of the current frame based on the density value, a node representing a spatial partition of the current frame; and generating the bitstream based on the at least one score threshold.

Clause 88. A method for storing a bitstream of a point cloud sequence, comprising: A method for storing a bitstream of a point cloud sequence, comprising: determining a density value of a current frame of the point cloud sequence, the density value indicating a density of point in at least a partition of the current frame; determining at least one score threshold for determining a prediction state of a sub-node of a node of the current frame based on the density value, a node representing a spatial partition of the current frame; generating the bitstream based on the at least one score threshold; and storing the bitstream in a non-transitory computer-readable recording medium.

### Example Device

FIG. 14 illustrates a block diagram of a computing device 1400 in which various embodiments of the present disclosure can be implemented. The computing device 1400 may be implemented as or included in the source device 110 (or the video encoder 114 or 200) or the destination device 120 (or the video decoder 124 or 300).

It would be appreciated that the computing device 1400 shown in FIG. 14 is merely for purpose of illustration, without suggesting any limitation to the functions and scopes of the embodiments of the present disclosure in any manner.

As shown in FIG. 14, the computing device 1400 includes a general-purpose computing device 1400. The computing device 1400 may at least comprise one or more processors or processing units 1410, a memory 1420, a storage unit 1430, one or more communication units 1440, one or more input devices 1450, and one or more output devices 1460.

In some embodiments, the computing device 1400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1400 can support any type of interface to a user (such as “wearable” circuitry and the like).

The processing unit 1410 may be a physical or virtual processor and can implement various processes based on programs stored in the memory 1420. In a multi-processor system, multiple processing units execute computer executable instructions in parallel so as to improve the parallel processing capability of the computing device 1400. The processing unit 1410 may also be referred to as a central processing unit (CPU), a microprocessor, a controller or a microcontroller.

The computing device 1400 typically includes various computer storage medium. Such medium can be any medium accessible by the computing device 1400, including, but not limited to, volatile and non-volatile medium, or detachable and non-detachable medium. The memory 1420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1430 may be any detachable or non-detachable medium and may include a machine-readable medium such as a memory, flash memory drive, magnetic disk or another other media, which can be used for storing information and/or data and can be accessed in the computing device 1400.

The computing device 1400 may further include additional detachable/non-detachable, volatile/non-volatile memory medium. Although not shown in FIG. 14, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1440 communicates with a further computing device via the communication medium. In addition, the functions of the components in the computing device 1400 can be implemented by a single computing cluster or multiple computing machines that can communicate via communication connections. Therefore, the computing device 1400 can operate in a networked environment using a logical connection with one or more other servers, networked personal computers (PCs) or further general network nodes.

The input device 1450 may be one or more of a variety of input devices, such as a mouse, keyboard, tracking ball, voice-input device, and the like. The output device 1460 may be one or more of a variety of output devices, such as a display, loudspeaker, printer, and the like. By means of the communication unit 1440, the computing device 1400 can further communicate with one or more external devices (not shown) such as the storage devices and display device, with one or more devices enabling the user to interact with the computing device 1400, or any devices (such as a network card, a modem and the like) enabling the computing device 1400 to communicate with one or more other computing devices, if required. Such communication can be performed via input/output (I/O) interfaces (not shown).

In some embodiments, instead of being integrated in a single device, some or all components of the computing device 1400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1400 may be used to implement video encoding/decoding in embodiments of the present disclosure. The memory 1420 may include one or more video coding modules 1425 having one or more program instructions. These modules are accessible and executable by the processing unit 1410 to perform the functionalities of the various embodiments described herein.

In the example embodiments of performing video encoding, the input device 1450 may receive video data as an input 1470 to be encoded. The video data may be processed, for example, by the video coding module 1425, to generate an encoded bitstream. The encoded bitstream may be provided via the output device 1460 as an output 1480.

In the example embodiments of performing video decoding, the input device 1450 may receive an encoded bitstream as the input 1470. The encoded bitstream may be processed, for example, by the video coding module 1425, to generate decoded video data. The decoded video data may be provided via the output device 1460 as the output 1480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, during a conversion between a current frame of a point cloud sequence and a bitstream of the point cloud sequence, a density value of the current frame, the density value indicating a density of point in at least a partition of the current frame;
determining at least one score threshold for determining a prediction state of a sub-node of a node of the current frame based on the density value, a node representing a spatial partition of the current frame; and
performing the conversion based on the at least one score threshold.

2. The method of claim 1, wherein determining the density value comprises at least one of:
determining the density value based on a number of occupied sub-nodes of preceding nodes coded before the current node, the preceding nodes having the same octree depth with the current node,
determining the density value based on a number of occupied sub-nodes of preceding nodes coded before the current node, the preceding nodes having a smaller octree depth than the current node, or
determining the density value based on a number of occupied neighbour nodes of the current node.

3. The method of claim 2, wherein the occupied neighbour nodes share at least one of the following with a sub-node of the current node: a face, an edge, or a vertex.

4. The method of claim 2, wherein the occupied neighbour nodes share at least one of the following with the current node: a face, an edge, or a vertex.

5. The method of claim 2, wherein the occupied neighbour nodes have a smallest distance with a sub-node of the current node or with the current node among a plurality of nodes.

6. The method of claim 1, wherein determining at least one score threshold based on the density value comprises:
determining the at least one score threshold based on a metric of the density value.

7. The method of claim 6, wherein the metric comprises one of the following:
a constant metric,
a piecewise metric,
a linear metric,
a power metric,
a logarithmic metric, or
an exponential metric.

8. The method of claim 1, further comprising:
including an indicator indicating whether to apply the method in the bitstream.

9. The method of claim 8, wherein including an indicator in the bitstream comprises:
including the indicator from an encoder to a decoder in one of the following: the bitstream, a frame, a tile, a slice, or an octree.

10. The method of claim 1, further comprising:
determining an indicator indicating whether to apply the method by at least one of: an encoder or a decoder.

11. The method of claim 10, wherein determining the indicator comprises:
determining the indicator based on a point cloud density.

12. The method of claim 8, wherein the indicator comprises a binary value.

13. The method of claim 8, wherein the indicator indicates whether occupancy information of nodes having the same octree depth with a current sub-node of the current frame is used to predict an occupancy bit of the current sub-node.

14. The method of claim 8, wherein the indicator is consistent in a coding unit, wherein the coding unit comprises one of the following: a frame, a tile, a slice, or an octree level.

15. The method of claim 8, wherein the indicator is consistent in the point cloud sequence.

16. The method of claim 1, further comprising:
including information indicating how to apply the method in the bitstream, wherein including information in the bitstream comprises:
including the information from an encoder to a decoder in one of the following: the bitstream, a frame, a tile, a slice, or an octree.

17. The method of claim 1, wherein the conversion includes encoding the current frame into the bitstream, or
wherein the conversion includes decoding the current frame from the bitstream.

18. An apparatus for processing point cloud data comprising a processor and a non-transitory memory with instructions thereon, wherein the instructions upon execution by the processor, cause the processor to perform acts comprising:
determining, during a conversion between a current frame of a point cloud sequence and a bitstream of the point cloud sequence, a density value of the current frame, the density value indicating a density of point in at least a partition of the current frame;
determining at least one score threshold for determining a prediction state of a sub-node of a node of the current frame based on the density value, a node representing a spatial partition of the current frame; and
performing the conversion based on the at least one score threshold.

19. A non-transitory computer-readable storage medium storing instructions that cause a processor to perform acts comprising:
determining, during a conversion between a current frame of a point cloud sequence and a bitstream of the point cloud sequence, a density value of the current frame, the density value indicating a density of point in at least a partition of the current frame;
determining at least one score threshold for determining a prediction state of a sub-node of a node of the current frame based on the density value, a node representing a spatial partition of the current frame; and
performing the conversion based on the at least one score threshold.

20. A non-transitory computer-readable recording medium storing a bitstream of a point cloud sequence which is generated by a method performed by a point cloud processing apparatus, wherein the method comprises:
determining a density value of a current frame of the point cloud sequence, the density value indicating a density of point in at least a partition of the current frame;
determining at least one score threshold for determining a prediction state of a sub-node of a node of the current frame based on the density value, a node representing a spatial partition of the current frame; and
generating the bitstream based on the at least one score threshold.
